(19) United States
(12) Patent Application Publication
(10) Pub. No.: US 2025/0083207 A1
(43) Pub. Date: Mar. 13, 2025

(54) PRESS BRAKE CONTROL INTERFACE ARM

(71) Applicant: Cincinnati Incorporated, Harrison, OH (US)

(72) Inventor: Jeffrey E.C. Higham, Rising Sun, IN (US)

(21) Appl. No.: 18/882,392

(22) Filed: Sep. 11, 2024

Related U.S. Application Data
(60) Provisional application No. 63/581,888, filed on Sep. 11, 2023.

(51) Int. Cl. B21D 5/02

(52) U.S. Cl. CPC B21D 5/0209

(57) ABSTRACT

An arm 12 for positioning a control system 14 of a machine tool 10 includes a first arm section 30 configured for horizontally pivoting. The first arm section 30 includes a plurality of linear sections 130, 132, 134, 136 angled with respect to each other. The first arm section 30 has a first downward vertical taper in height from a proximal end 33 to the distal end 35 of the first arm section. The first arm section also has a second downward vertical taper in height from an innermost side 110 of the first arm section to an outermost side 114 of the first arm section 30.

### PREVIOUS APPLICATIONS

This application claims the priority and benefit of U.S. Provisional Patent Application 63/581,888 filed on Sep. 11, 2023 and entitled PRESS BRAKE CONTROL INTERFACE ARM.

### TECHNICAL FIELD

This application is directed to a control interface for machine tools, and more particularly to an interface arm for use in supporting systems for controlling such machine tools.

### BACKGROUND OF THE INVENTION

Various machine tools, such as an hydraulic press brake, incorporate control systems that are manipulated by the user to operate the press brake or other machine tool. A press brake is a machine used for bending sheet metal and metal plate, and most commonly sheet metal. A press brake forms predetermined bends in a metal sheet by clamping the workpiece between a matching top tool and bottom die or bed. Such tools can often be large, and the user moves back and forth with respect to the front of the machine arranging parts or otherwise engaging the machine during a press brake operation.

Generally, many of the moving elements of the machine and the workpieces are located at the front of the machine, making the location of the control system, for access by a user at the front, a sometimes difficult scenario. The bed of the press brake must be free around the front of the bed. Often parts have to be manipulated at the front and carts have to be rolled in the front at certain stages of the operations. These factors make a fix front mount of the control systems difficult.

Accordingly, there is a need for a control system that is readily accessible to a user at the front of the machine tool, but which does not interfere with the operation and access to the machine. There is a further need for a control system that may be positioned at various positions as needed and that can be moved away from the front of the machine to allow greater access as desired.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a perspective view of a machine tool using the control interface arm in accordance with an embodiment of the invention.

FIG. 2 is a top view of a machine tool using the control interface arm in accordance with an embodiment of the invention.

FIG. 3 is a front view of a machine tool using the control interface arm in accordance with an embodiment of the invention.

FIG. 4 is a front perspective view of a control interface arm in accordance with an embodiment of the invention.

FIG. 5 is a rear perspective view of a control interface arm in accordance with an embodiment of the invention.

FIG. 6 is a top view of a control interface arm in accordance with an embodiment of the invention.

FIG. 7 is a partially exploded perspective view of a section of a control interface arm in accordance with an embodiment of the invention.

FIG. 8 is a perspective view of an end section of a control interface arm in accordance with an embodiment of the invention.

FIG. 9 is an exploded perspective view of a knuckle portion in a control interface arm in accordance with an embodiment of the invention.

FIG. 10 is a side cross-sectional view of a knuckle portion in the control interface arm in accordance with an embodiment of the invention.

FIG. 11 is an exploded perspective view of the knuckle portion in the control interface arm in accordance with an embodiment of the invention.

FIG. 12A is an exploded perspective view of a section of the control interface arm in accordance with an embodiment of the invention.

FIG. 12B is another exploded perspective view of a section of the control interface arm in accordance with an embodiment of the invention.

FIG. 13 is a side view of a section of the control interface arm in accordance with an embodiment of the invention.

FIG. 14 is a cross-sectional view of ends of the control interface arm in accordance with an embodiment of the invention.

FIG. 14A is an enlarged cross-sectional view of the proximal end of the control interface along lines 14A-14A of FIG. 6 in accordance with an embodiment of the invention.

FIG. 14B is an enlarged cross-sectional view of the distal end of the control interface arm along lines 14B-14B of FIG. 6 in in accordance with an embodiment of the invention.

FIG. 15 is an exploded perspective view of a section of the control interface arm in accordance with an embodiment of the invention.

FIG. 16 is a perspective view of an outer rib of a section of the control interface arm in accordance with an embodiment of the invention.

FIG. 17 is a perspective view of an inner rib of a section of the control interface arm in accordance with an embodiment of the invention.

FIG. 18 is a perspective view of a center rib of a section of the control interface arm in accordance with an embodiment of the invention.

FIG. 19 is a perspective view of a top or bottom plate of a section of the control interface arm in accordance with an embodiment of the invention.

FIG. 20 is a side view of a rib of a section of the control interface arm in accordance with an embodiment of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF EMBODIMENTS OF THE INVENTION

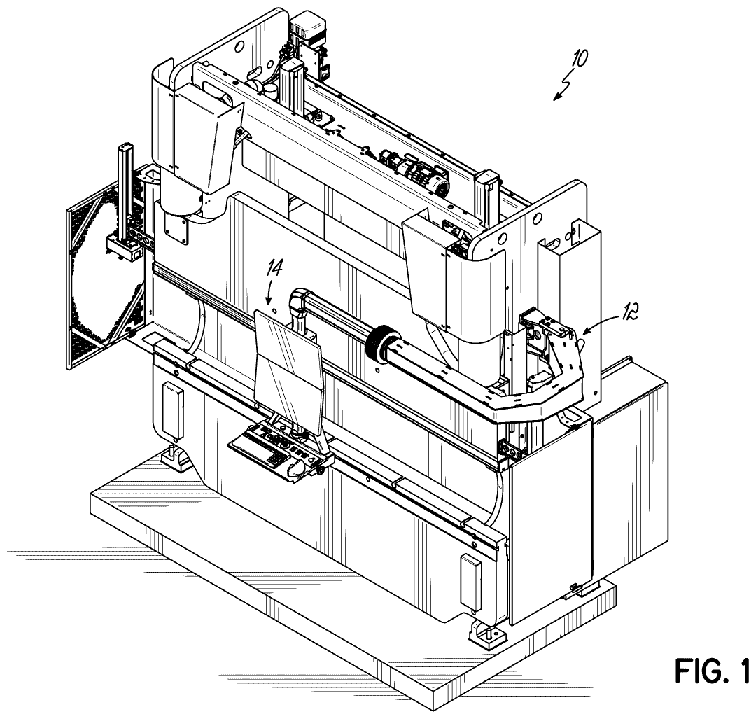

FIGS. 1 to 3 are perspective views of a machine tool, in the illustrated example, a press brake machine tool, incorporating the control interface arm of the present invention. The control interface arm may be used with other tools and machine tools and the press brake shown is used only for illustrative purposes and is not limiting as to how the invention is used or implemented.

FIG. 1 illustrates a perspective view showing the tool 10, such as a press brake tool, having a control interface arm 12 extending from a side of the tool, and then around toward the front of the tool 10 to provide a user (not shown) with access to a machine control system 14 proximate to the front of the tool 10. As illustrated in the FIG. 1, the control interface arm 12 is mounted on a right side of the tool 10 looking at the front of the tool. As such, the embodiment of the invention as illustrated is configured for mounting on that right side. However, the control interface arm might be mounted on the opposite side of a tool, with appropriate mirroring and adjustment to the various elements making up the control interface arm as would be understood by a person of ordinary skill in the art.

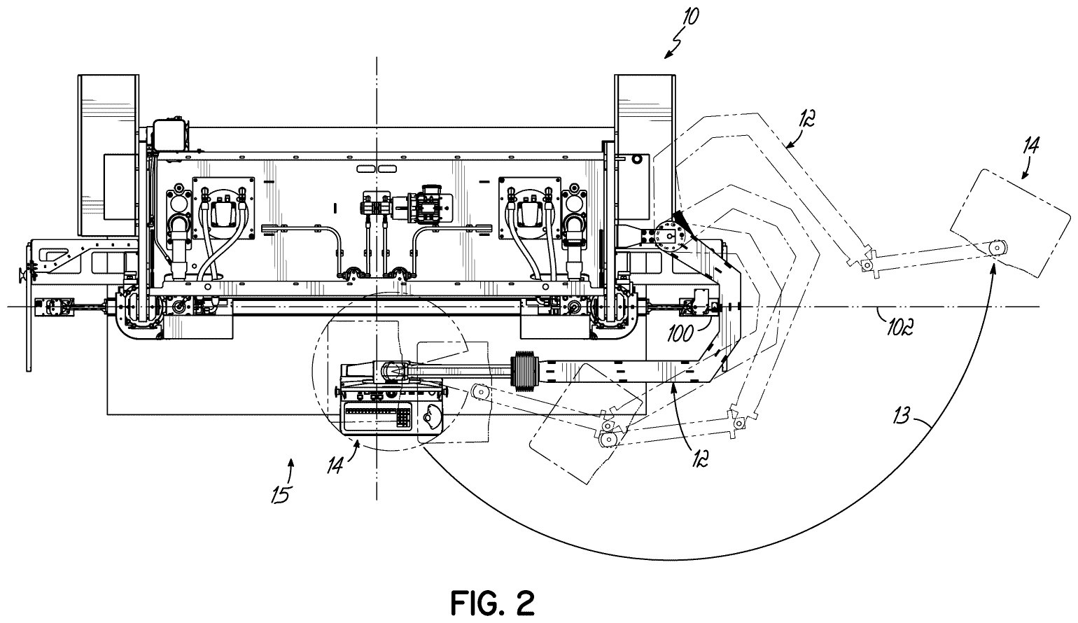

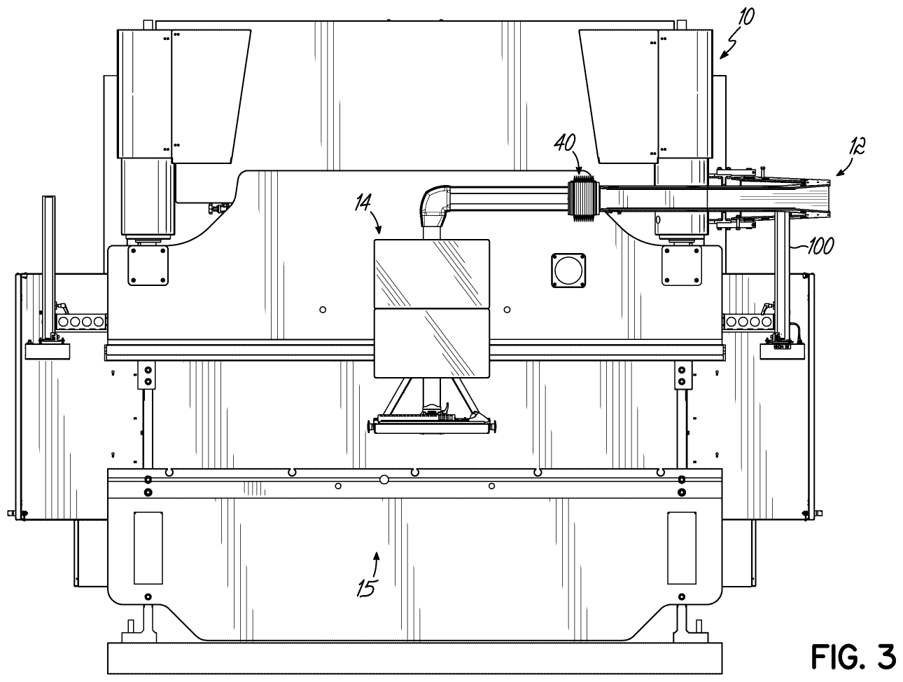

The control interface arm 12 of the invention is coupled to a side of the machine and is uniquely configured to move and present the control system 14 and related elements at the front side or front 15 of press brake as illustrated in FIG. 2. The control interface arm 12 provides a clearance around the side of the press brake tool 10, thus avoiding interference with one or more safety devices or safety systems 100 as shown in FIG. 3. Simultaneously, the control interface arm 12 is configured and operable for presenting the control system 14 at the front of the machine generally in the center of the machine for access by the user during operations. The control interface arm 12 is also configured and operable to be movable for providing adjustability of the control system 14 with respect to the user and the tool 10 as shown in FIG. 3.

Furthermore, the control interface arm 12 allows the control system and portions of the arm to be moved away from the front of the press brake 10 to provide greater access to the workspace, such as for a procedure or maintenance, or for allowing a cart or other tools to be moved along the front of the press brake. The inventive control interface arm 12 is uniquely constructed and configured to cantilever the weight of a control system 14 and its components from the side of the press brake all the way to a significant distance and to the center of the press brake as illustrated in FIG. 2. FIG. 2 shows various positions of the control interface arm 12 and the control system 14 that are provided by the invention during its use.

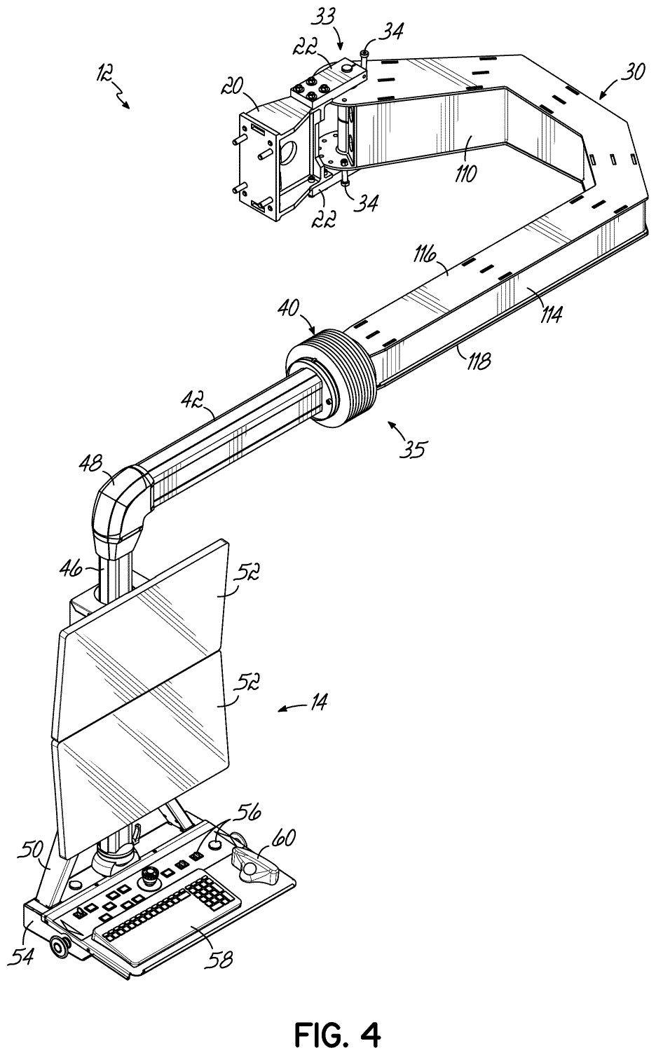

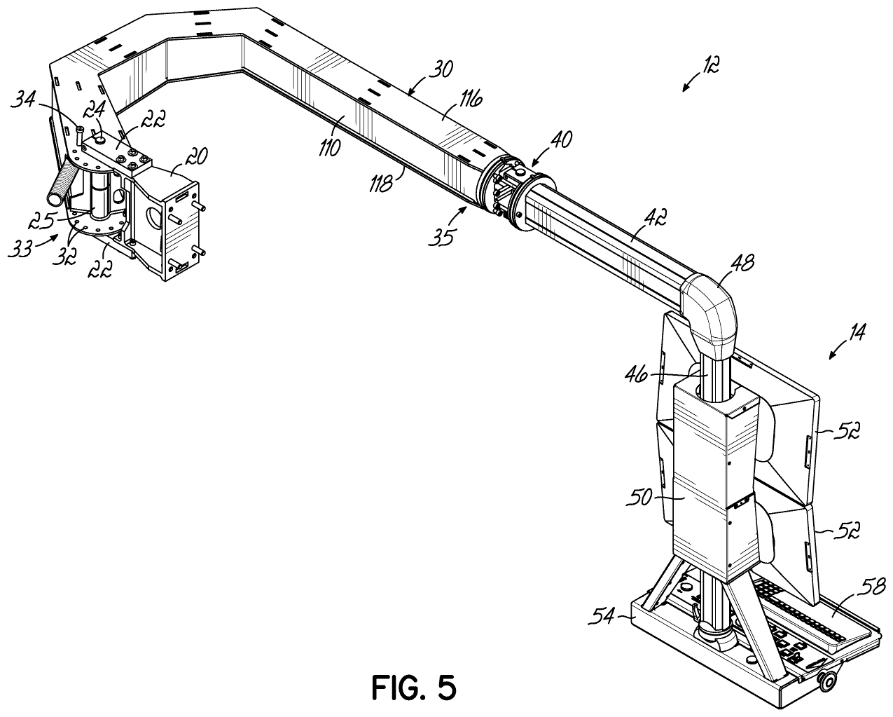

As shown in FIG. 3, the control interface arm 12 mounts to the side of the press brake tool and presents the control system at different positions at the front of the tool. Referring to FIGS. 4, 5 and 6, the control interface arm 12 incorporates several elements for providing the inventive features of the arm. Specifically, referring to FIG. 4, the control interface arm 12 utilizes a pivot bracket 20 which attaches to the side of the press brake tool 10, such as by being bolted to a side surface or other component located at the tool side. As noted, facing tool 10, the control interface arm 12 is mounted to a right side, such as to a plate 11 of the tool frame.

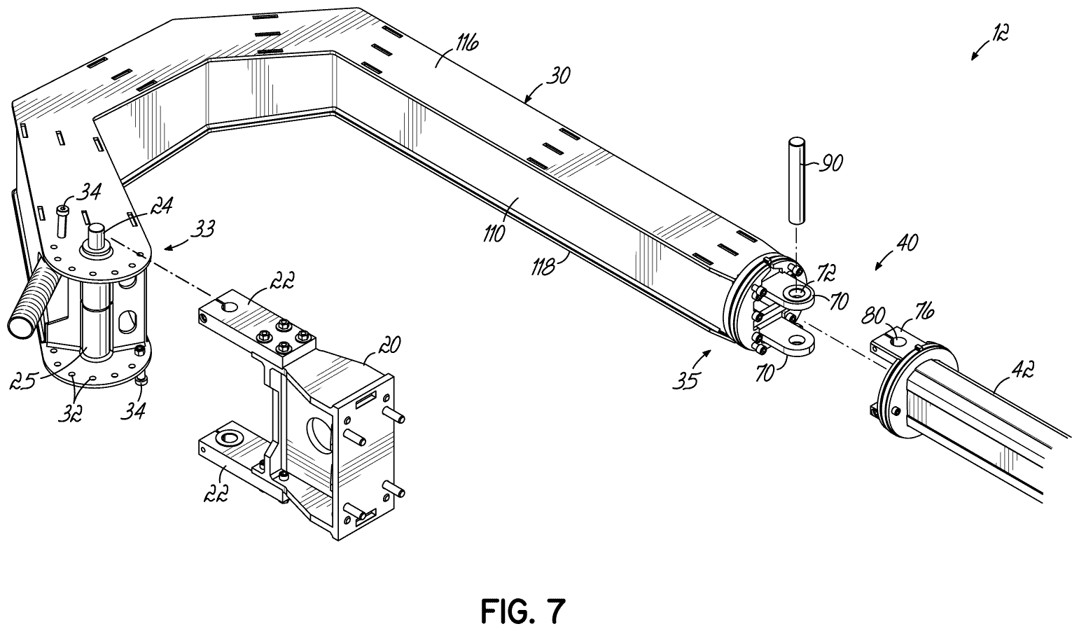

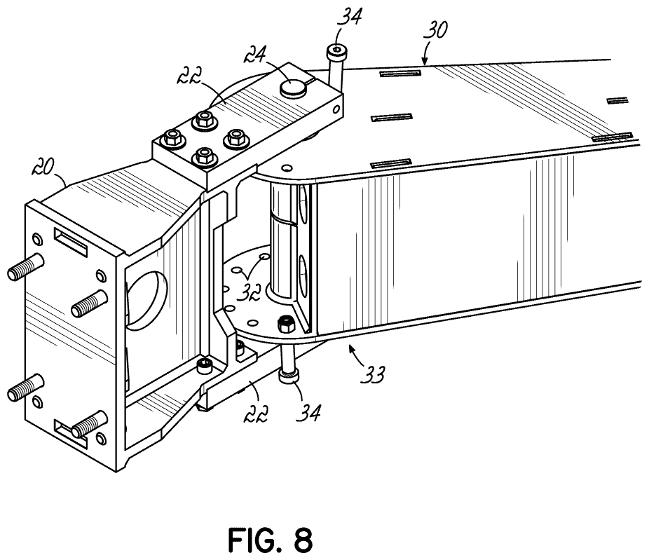

Referring to FIG. 7, bracket 20 includes support tabs 22 which capture and secure a pin or other rotational axis element 24 to present a vertical axis for arm 12. A rigid angled arm section 30 has a proximal end 33 that is proximate to the bracket 20 and that receives the axis element 24 to allow the arm section 30 to pivot in azimuth from the side of the press brake 10 as illustrated in the various positions of FIG. 2. The arm section 30 also has a distal end 35. As shown in FIG. 7, the pivoting proximal end 33 of arm section 30 incorporates a series of holes or apertures 32 for securing one or more limit or stop elements 34 to the arm section 33 to limit the rotation of arm section 30 with respect to the bracket 20 and axis element 24 as shown in FIG. 8. Similar apertures 32 may be placed on the top and bottom of the proximal end 33 of the control arm 30 as shown in FIGS. 7-8 so that different stop elements 34 might be used for different rotational positions of the arm section 30. For example, a stop element positioned at the top surface or top plate 116 of arm section 30 may limit the amount of travel of the pivoting arm 12 when it is moved away from the front 15 of the press brake tool 10 to a position out of the way of the machine is illustrated in FIG. 2. Alternatively, another stop element 34 might be implemented on the bottom or bottom plate 118 of the arm section 34 limiting the travel of the pivoting arm 12 when it is moved to position the control system 14 at the front of the press brake as shown in FIGS. 1-3 but to prevent the interface control arm and control system from contacting the front of the tool 10.

More specifically, referring to FIGS. 7 and 8, the stop elements 34 are shown at the top and bottom of the arm section 30 and particularly proximate to the end of the arm section 30 in different positions around an arc in the end of the arm section 30 with respect to bracket 20. The arc is formed by the placement of the apertures 32. In that way, the stop elements 34 may be utilized to engage one or more of the stop apertures 32 and then will contact one or more of the respective support tabs 22 to provide a desired range of movement of the pivoting arm section 30. Again, as illustrated in FIG. 2, the control interface on 12 may be moved to a number of different positions for use.

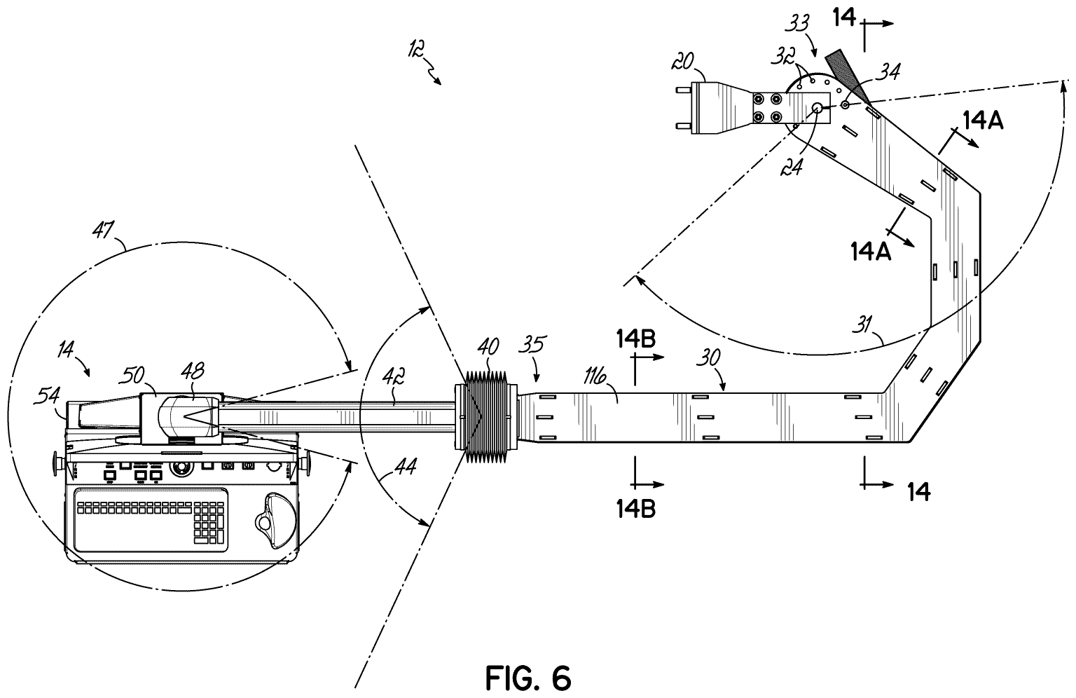

The control interface arm 12 has additional adjustable sections that provide for movement of the control system 14 to a desired position by the user so that they may utilize the press brake and control the press brake from a number of different positions. For example, the control interface arm 12 may be swung in the arc 13 as shown in FIG. 2 while portions of the control interface arm as discussed herein also move to provide a wide range of positioning for the control system 14 with respect to the press brake 10. As shown in FIG. 6, depending on the position of the stops, the arm section 30 may move in an arc 31 of around 144°.

Referring to FIG. 6, interface control arm 12 also incorporates a knuckle 40 that couples the arm section 30 with another arm section 42. The knuckle 40 provides a vertical pivot axis which allows pivoting of arm section 42 with respect to arm section 30 at the knuckle 40 around in arc 44 over a span of approximately 130°. That is, the arm section 42 pivots independently of the pivoting of arm section 30. Arm section 42, in turn, couples with a vertical leg section 46 at an elbow 48 to which a support frame 50 is mounted. Support frame 50 may rotate on leg section 46 around arc 47 approximately 330° around the longitudinal axis of the leg section 46. The frame 50 has mounting features for holding one or more control screens 52 as well as a shelf portion 54 for holding other controls 56, a keyboard 58 and/or a mouse 60. In accordance with one embodiment of the invention, the arm section 42, elbow 48, leg section 46, and frame 50 might be commercially available mounting hardware that may be configured for working within the interface control arm 12 of the invention. As may be appreciated, the present invention is not limited to the type of control system 14 or the various screens and human interface components implemented with the control interface arm 12.

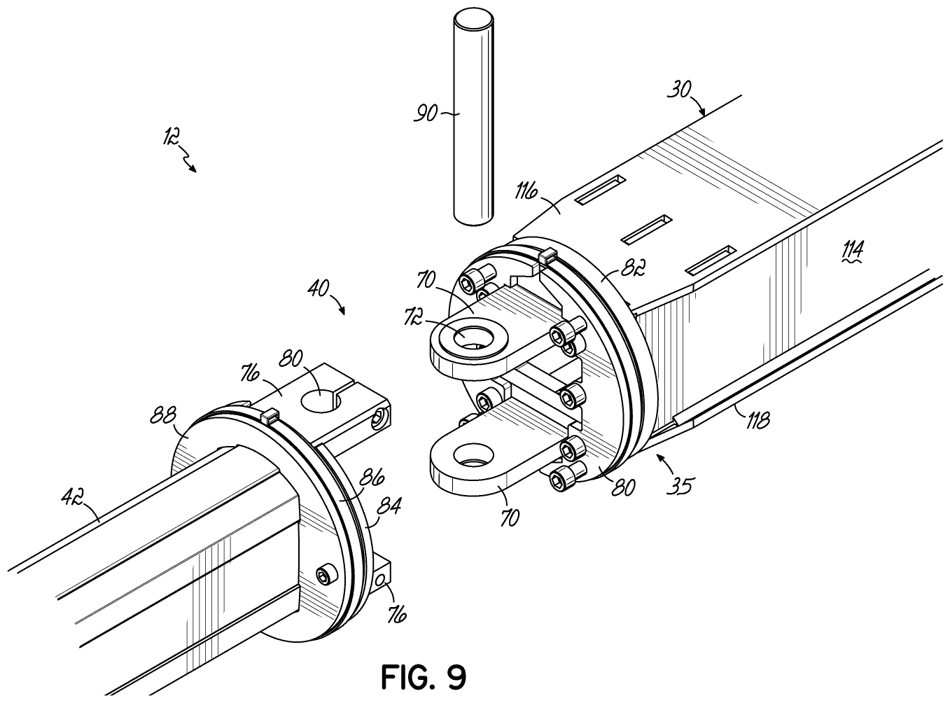

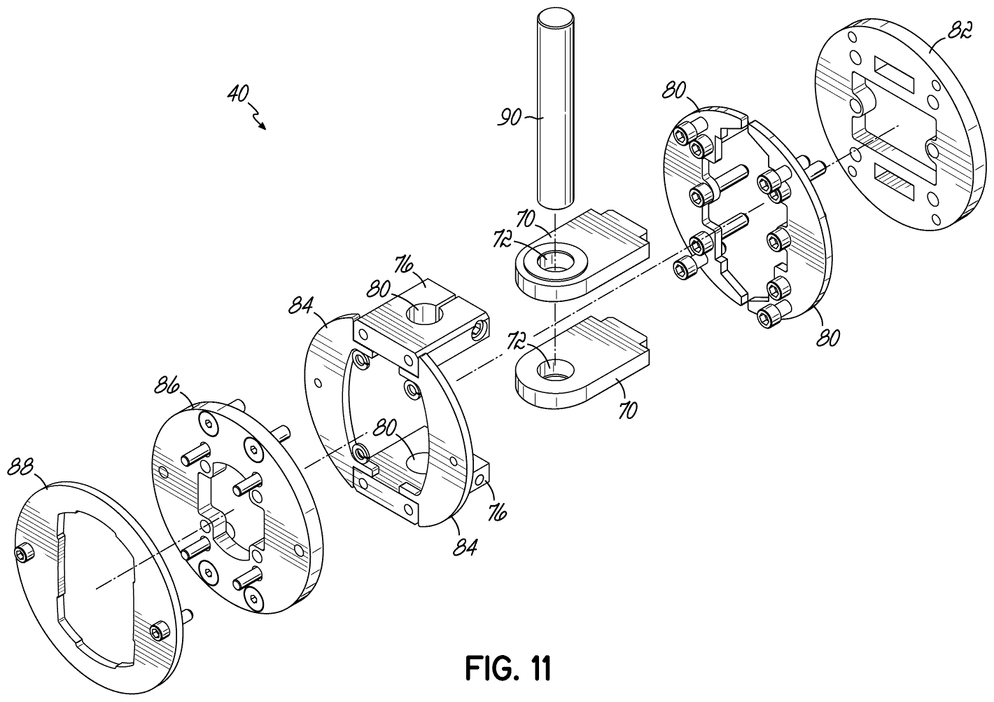

Referring now to FIG. 9, an exploded view of the knuckle 40 is shown. The knuckle 40 provides a vertically disposed hinge pin 90 and axis to allow pivoting in azimuth of the arm section 42 with respect to arm section 30. Specifically, the arm section 30 includes tabs 70 having respective apertures 72 therein. Similarly, arm section 42 includes tabs 76 having apertures 80 therein. The tabs 70 are mounted to arm section 30 through one or more mounting plates 80, 82 and appropriate fasteners as shown in FIG. 11. Similarly, the tabs 76 are mounted to arm section 42 through one or more mounting plates 84, 86, 88 and appropriate fasteners. Suitable bolts or other fasteners as shown in FIG. 11 may be utilized to couple the plates together as well as to couple those plates to the respective arm sections and respective tabs.

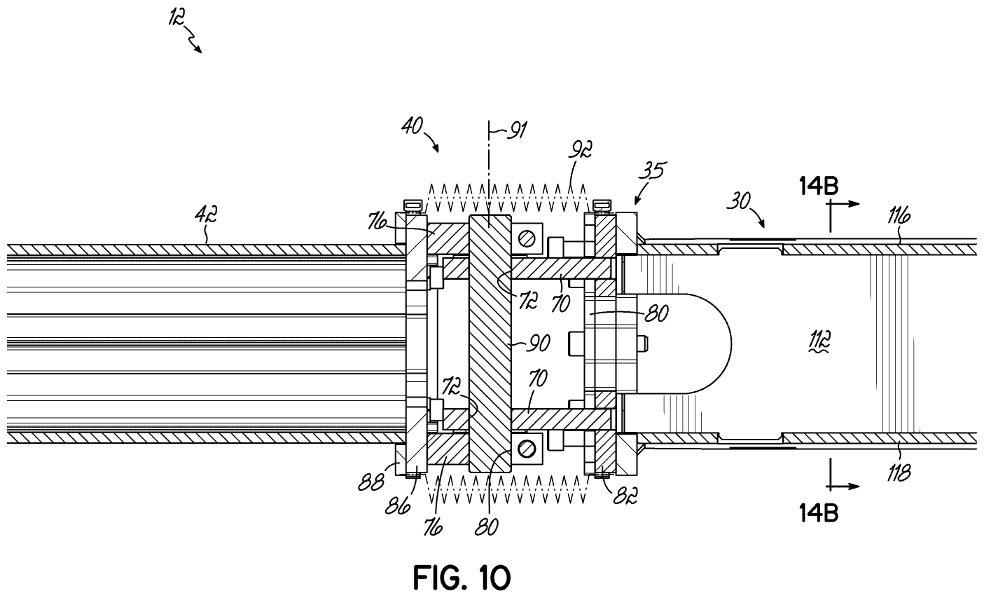

As illustrated in FIGS. 9-11, the respective tabs 70 and 76 of each of the arm sections are vertically offset to allow the tabs to overlap such that apertures 72 and 80 align to receive pin 90. The hinge pin 90 then extends through the apertures and through the respective tabs to define the vertical hinge axis 91 is shown in FIG. 10. This provides horizontal pivoting or azimuth hinging between the arm sections 30 and 42 to provide the azimuth adjustment of one arm section with respect to the other as shown in FIG. 2 once the interface control arm is swung into position for use. As illustrated in FIG. 6, the azimuth movement arc 44 provides adjustment of the control system 14 as desired through the interface control alarm, and the control system may be moved through various positions as shown in FIG. 2 to allow flexibility for a user to control the press brake 10 from different positions as well as to provide space in front of the press brake and access to the tool, such as for work processes or maintenance. To protect the components of knuckle 40, and to contain components and any lubricants used, a flexible cover 92 may be implemented to cover different elements and sections of the knuckle, as illustrated in FIG. 10.

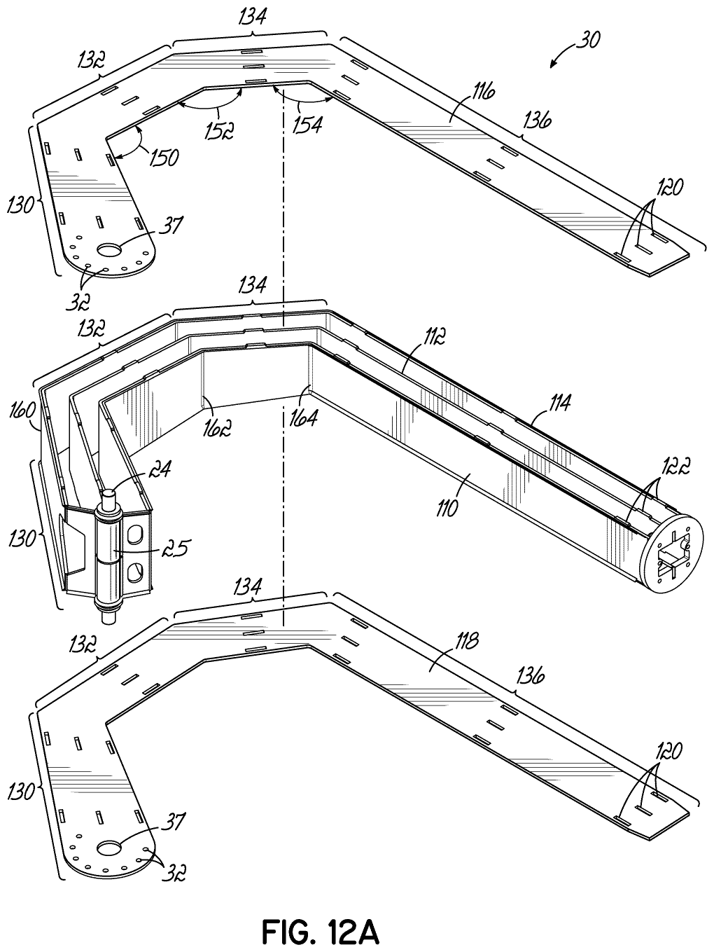

To support the significant weight of the control system that is cantilevered a significant distance from the tool on the arm 12, the arm section 30 is uniquely constructed and configured to provide robust support but maintain a lightweight design so that it might be more easily moved and positioned as desired. To that end, FIGS. 12A, 12B, 13, 14 and 14A, 14B illustrate exploded cross-sectional views of section 30 and the elements of the section of the control interface arm 12 of the invention. The arm section 30 is uniquely configured and constructed to provide movement of the arm as well as positioning of a control system 14 around a long machine, such as a 10 foot long press brake tool 10 while providing rigidity from twisting from the weight of the control system cantilevered out from the arm 12 while at the same time reducing the weight of the arm itself for easier user manipulation. Arm section 30 has a unique construction and configuration to provide the movement illustrated in FIG. 2 while allowing the control interface arm 12 to avoid collision with elements of the press brake, such as safety devices. For example, machine tools, such press brakes, often create a lot of force between the tools, dies, and other sections of the moving machine tool. To avoid injury to a user, safety systems are utilized to prevent actuation of a tool if a person's body or hand is in front of the movable portion of the tool. To that end, various safety mechanisms, such as laser devices as illustrated in FIGS. 2 and 3 may be positioned appropriately, such as in the center line of work 102 of the press brake to detect interference with the tool, such as by a user's arm or hand. Control interface arm 12 attached to the side of the press brake 10 is configured to avoid interference with any safety systems 100 while providing various different positions of the control system 14 with respect to the tool.

To that end, the interface control arm section 30 incorporates a combination of components or sections that are disposed at selective angles to present the knuckle and arm section 42 in different positions. The arm section 30 uses a combination of uniquely configured and vertically disposed ribs to provide the desired strength and rigidity to provide support of the control system without significant twisting while still keeping the arm light and maneuverable. Furthermore, the arm section 30 provides a unique tapering construction for increased rigidity in a light weight and maneuverable design. Specifically, the arm section incorporates multiple unique tapers to achieve that result.

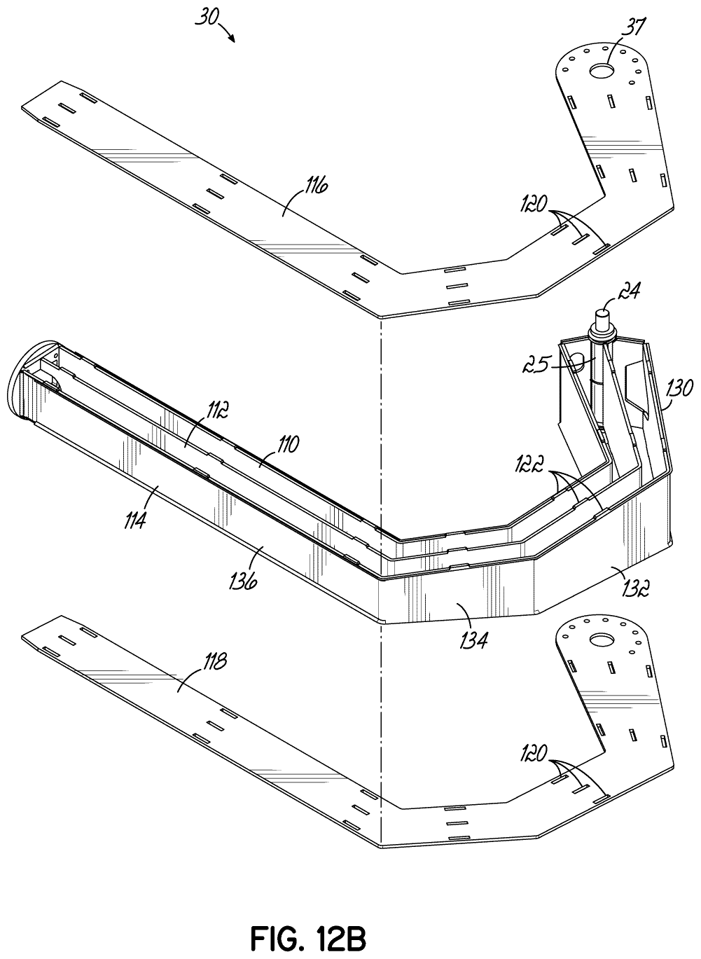

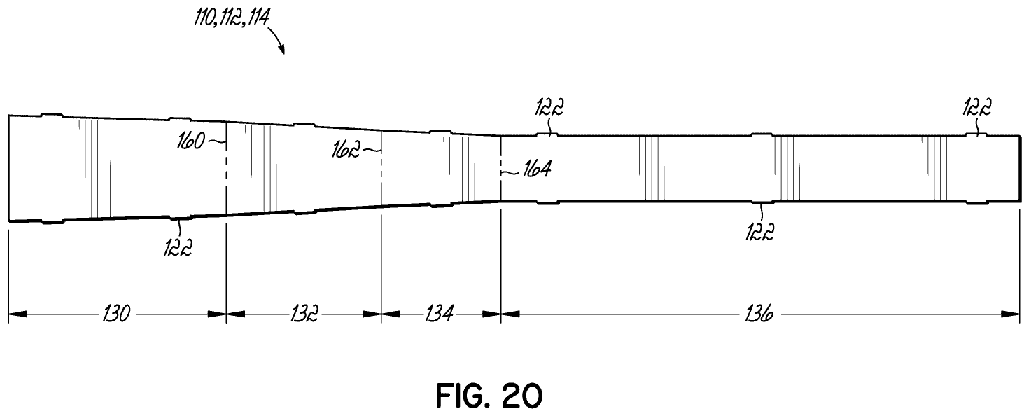

Referring to FIG. 12A and 12B, and section 15, arm section 30 utilizes a series of aligned ribs 110, 112, 114 that are vertically oriented and uniquely constructed and angled to provide for a rigid arm section with strength and a relatively light weight. Referring to FIG. 12A, each of the ribs has a series of straight or linear portions which unite at unique angles to form the control interface arm section 30 and provide the adjustability is illustrated in FIG. 2. Specifically, arm section 30 incorporates generally flat ribs 110, 112, 114 that extend generally vertically and generally parallel to each other. The ribs are bent at bend lines 160, 162, 164 as shown in FIGS. 13 and 20. The various bent portions of the ribs form a series or plurality of linear sections 130, 132, 134, and 136 and each of those respective linear sections of a rib extend generally parallel to each other along the length of the arm section 30. The ribs are covered by a top plate 116 forming a top surface and a bottom plate 118 forming a bottom surface to complete the arm section 30. The top and bottom plates may be appropriately formed sheet metal configured for interfacing with the ribs. Inner and outer ribs form the side surfaces of the arm section 30 as shown in FIGS. 12A-12B. The ribs 110, 112, 114 include tabs 122 that are formed along top and bottom edges 123, 125 of each rib (See FIG. 20). Each of the top plate 116 and the bottom plate 118 have a series of slots 120 which engage with respective tabs 122 on various ribs to provide alignment and positioning of the ribs in the arm section 30. Also, each of the top plate and bottom plate 116, 118 include linear sections that are coupled together at unique angles, resembling various of the angled linear sections of the ribs so that all of the sections align along the arm section 30 as shown in FIGS. 12A, 12B.

As illustrated in FIG. 12A, 12B, the ribs 110, 112, 114 and top plates 160, 118 are configured to come together and capture and interface with hinge pin 24. The proximal ends of the ribs interface with a sleeve 25 that is at the proximal end 33 of the arm section 30. The ends of the ribs 110, 112, 114 and top plates 160, 118 might be appropriately secured with the sleeve 25, such as by welding. The hinge pin 24 passes through the sleeve 25 and the support tabs 22 that are held by bracket 20 to provide pivoting of the arm section 30. The plates 116, 118 have apertures 37 provided therein for aligning with the sleeve and allowing the hinge pin 24 to pass through as shown in FIGS. 12A and 12B.

Referring to FIGS. 12A, 12B and 20, the ribs and plates forming the arm section are configured for forming respective linear sections 130, 132, 134 136 that extend sequentially from the hinge pin 24 and mounting bracket 20 at unique angular orientations. Four linear sections 130, 132, 134 136 are formed in the illustrated embodiment. The linear sections may have different lengths as appropriate. The different linear sections might also be angled with respect to each other at different angles. The most proximal linear section 132 interfaces with linear section 130 at an interface angle 150 in a range of 116° to 126° and in one embodiment at an angle of approximately 121°. The linear section 134 interfaces with linear section 132 at an interface angle 152 in a range of 140° to 150° and in one embodiment at an angle of approximately 145°. Finally, linear section 136 interfaces with linear section 134 at interface angle 154 in a range of 120° to 130° and in one embodiment at an angle of approximately 125°. Together, as seen in FIGS. 6 and 7, the arm section 30 forms an arcing arm section in accordance with the invention. Each of the ribs 110, 112, 114 of the arm section may be formed of flat metal blank elements as shown in FIG. 20 with respective bend lines 160, 162 and 164 as illustrated in FIGS. 13, 20.

In accordance with one feature of the invention, each of the ribs 110, 112, 114 tapers downwardly vertically in cross-sectional height as they extend from the proximal end 33 and mounting bracket 20 out to the distal end 35 for engagement with knuckle 40. Specifically, as illustrated in FIGS. 13 and 20, wherein linear section 130 is the tallest height at the proximal end and tapers downwardly toward the distal end and linear section 136. The linear section 130 tapers downwardly in height to bend line 160 where the ribs are bent to delineate with section 132. The linear sections 132, 134 further taper downwardly respectively in vertical height from the respective bend lines 162, 164 down to the linear section 136. In the illustrated embodiment, the distal end linear section 136 generally is not tapered along its length in the disclosed embodiment. Each of the various ribs 110, 112, 114 will taper in the vertical direction in height progressing from the proximal end 33 and bracket 20 to the distal end 35 and knuckle 40. In that way, the arm section 30 that is formed by the cooperation of the ribs 110, 112, 114 and top plate 116 and bottom plate 118 will taper downwardly in the vertical direction in height from the proximal end 33 and bracket 20 to the distal end 35 and knuckle 40 as illustrated in FIGS. 12A, 12B.

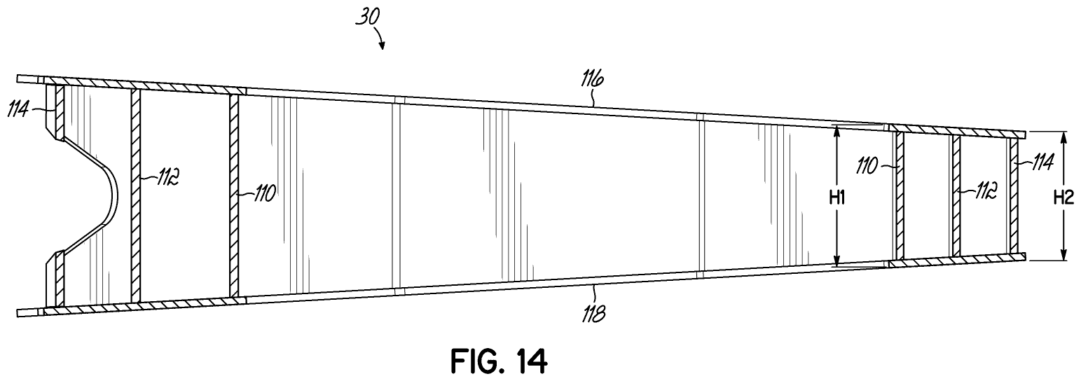

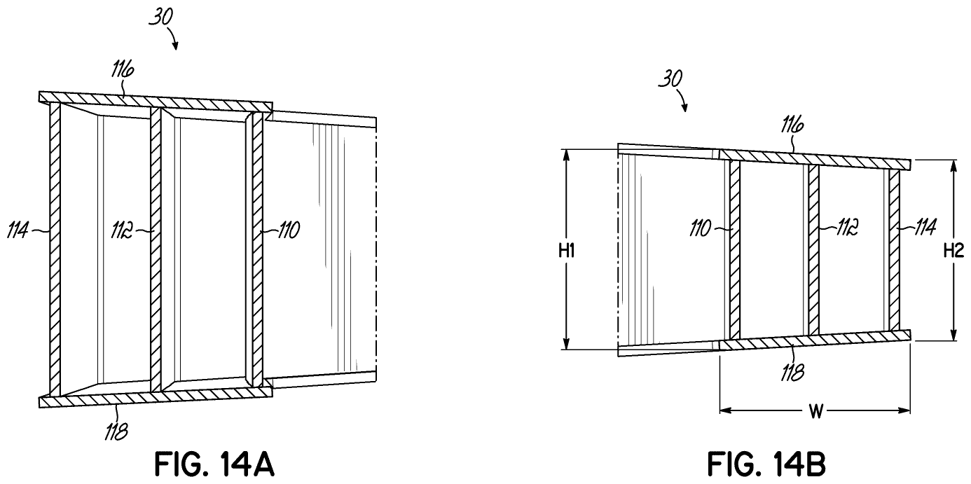

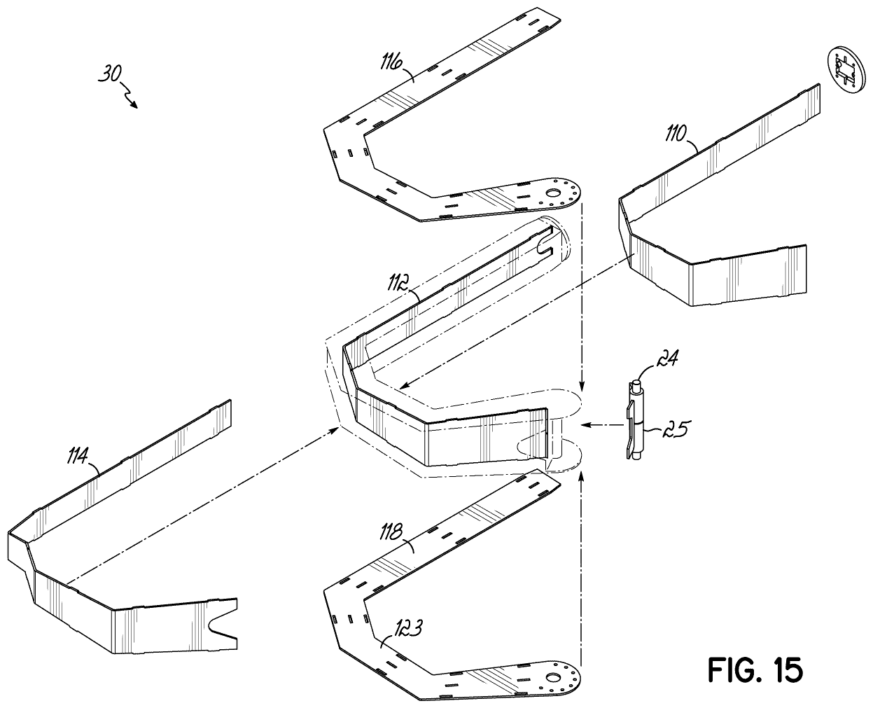

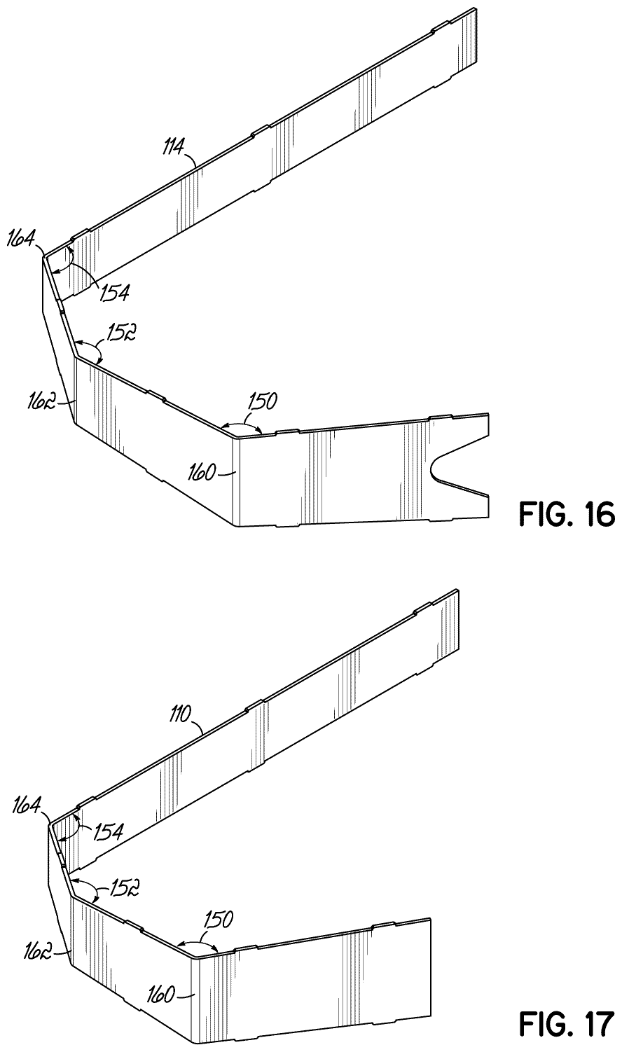

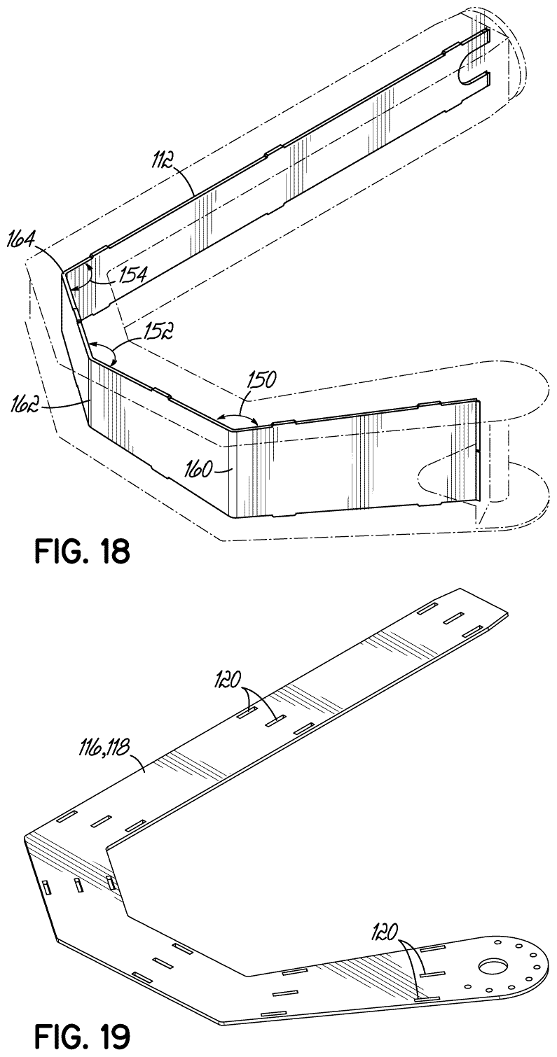

Generally, the ribs 110, 112, 114 will be bent at similar interface angles 150, 152 and 154 as shown in FIG. 12A and 15 with respect to arm section 30. Due to their placement within arm section 30 across the width of the arm and the flare in width at the linear section 130 in the top and bottom plates 116, 118, the bends at the interface angles 150, 152 and 154 may vary slightly one from the other. For example, for the innermost rib 110 as shown in FIG. 17, the interface angles will match the interface angles of the overall arm as set forth herein at approximately 121°, 145°, and 125°. However, for the center rib 112 as shown in FIG. 18 the interface angles 150, 152 and 154 might be approximately 125°, 145°, and 125°. Finally, for the outermost rib 114 as shown in FIG. 16, interface angles might be approximately 128°, 145°, and 125°. This allows for the linear section 130 of the arm to flare in width proximate to the connection with bracket 20 as shown in FIGS. 12A and 19.

Similarly, the various lengths of the different linear sections 130, 132 134 136 will vary between the different ribs, 110, 112 and 114 due to the width of the arm section 30 to provide the desired interface angles of the arm sections. As may be appreciated, the length of the ribs will vary depending on the size and length of the tool. For example, the linear sections 130, 132, 134 and 136 of the innermost rib 110 in FIG. 17 might be, respectively, approximately 15 inches, 10.7 inches, 8.3 inches, and 36 inches for an arm used on approximately 10 foot press brake. As may be seen in FIG. 12A, to maintain the interface angles and parallel rib linear sections along the arm from the innermost rib to the outermost room, the various linear sections are lengthened. For example, the center rib linear sections 130, 132, 134 136 of approximately 15.4 inches, 12.5 inches, 10 inches, and 37.3 inches. Similarly, the outermost rib may have linear sections 130, 132, 134 136 of approximately 15.8 inches, 14 inches, 11.6 inches and 38 inches. The upper and lower plates 116, 118 are appropriately configured to cover all of the ribs forming arm section 30 as illustrated in FIG. 12A. While the proximal end of arm section 30 is configured for interfacing with bracket 20, the distal end is configured for interfacing with one or more of the plates 80,82 making up part of the knuckle 40. As may be appreciated, the specific invention is not limited to particular

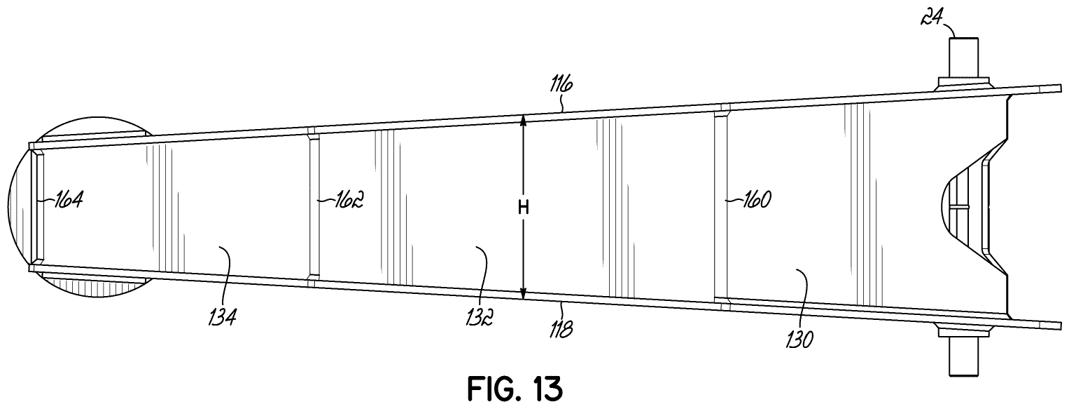

In accordance with one aspect of the invention, in addition to the downward taper of the arm in cross-sectional vertical height along the length of the arm and the linear sections from the proximal end 33 to the distal end 35, the arm section 30 also tapers downwardly in cross-sectional vertical height across the width of the arm section from the innermost rib to the outermost rib, as shown in FIGS. 14, 14A, 14B. That is, as the ribs taper downwardly in vertical height from the proximal end 33 of the arm section 10 to the distal end 35, the taper is more drastic in the outer rib 114 than in the inner rib 110. That is, referring to FIG. 14B, the inner height H₁ of inner rib 110 remains higher than the height H₂ of the outer rib 114 at the distal end 35. Therefore, the taper in height also occurs along the cross-sectional width of the arm section 30 from the inner side defined by rib 110 to the outer side provide by rib 114, progressing along the arm section length from proximal end 33 to distal end 35. The outer rib 114 starts as the tallest rib in height at the proximal end 33, as shown in FIG. 14A, and then tapers to be the shortest rib in height at the distal end 35, as seen in FIG. 14B. Similarly, the inner rib 110 starts as the shortest rib and then tapers less to then be the tallest rib at the distal end as seen in the FIGS. 14, 14A, 14B. The tapers of the ribs progress downwardly until the final linear section 136 wherein the ribs maintain their final generally consistent cross-sectional shape and height throughout the rest of the length of the arm.

Accordingly, in order to present the control system out at the front of the tool 10, the control interface arm uses a dual taper design to cantilever the control system into position. The control interface arm 12 tapers along its length in vertical height from the proximal end 33 to the distal end 35. Also, across the width W of the arm 12 a taper vertically downwardly occurs from the innermost side or rib to the outmost side or rib so that the innermost rib 110 creates an arm with a greater thickness at the inside of the arm where the control system is supported.

Therefore, the taper in height from the inner side to the outer side of the arm section 30 across the width at the distal end, as shown in FIG. 14B, is maintained out along the length of linear section 136 of the arm section 30. For example, in an arm for a 10 foot press break, the outermost rib 114 tapers down from the height at the proximal end of approximately 7.8 inches down to a height at bend line 164 and the distal end of approximately 4 inches, which is then maintained out through the length of the linear section 136. The center rib 112 begins at a height of around 7.6 inches and tapers down to its respective bend line 164 at the distal end to a height of approximately 4.2 inches. Finally, the innermost rib 110 tapers from its initial height of 7.3 inches down to the distal end and bend line 164 of approximately 4.4 inches. Accordingly, the interface control arm 12 of the invention incorporates a two directional cross-sectional taper along the length of a portion of the arm, as defined by the linear sections then across the width of the arm from the outmost rib 114 to the innermost rib 110 is illustrated in FIG. 14. FIG. 14 shows a greater height H₁ of the innermost 110 than the height H₂ of the outermost rib 114, as shown is a cross-section 14B with respect to FIG. 6. That is, a taper across the width of the arm is illustrated where the arm section 30 interfaces to knuckle 40, as shown in FIG. 6. This unique two directional taper in cross-sectional height provides the control interface arm with improved stiffness while maintaining a lightweight and smaller dimensioned arm to allow for manipulation by a user.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. An arm for positioning a control system of a machine tool comprising:
a first arm section configured for horizontally pivoting, the first arm section including a plurality of linear sections angled with respect to each other;
the first arm section having a first downward vertical taper in height from a proximal end to the distal end of the first arm section;
the first arm section having a second downward vertical taper in height from an innermost side of the first arm section to an outermost side of the first arm section.

2. The arm of claim 1 wherein the first arm section further comprises a plurality of ribs extending along the length of the arm for forming the linear sections, each of the ribs having a first downward vertical taper in height from a proximal end to the distal end of the first arm section.

3. The arm of claim 2 wherein the first arm section further comprises a plurality of ribs extending along the length of the arm for forming the linear sections, the plurality of ribs including at least an innermost rib and an outermost rib, the ribs having a second downward vertical taper in height from the innermost rib of the first arm section to the outermost rib of the first arm section.

4. The arm of claim 3 wherein the first arm section further comprises a center rib between the innermost rib and the outermost rib, the center rib having a second downward vertical taper in height between the height of the innermost rib and the height of the outermost rib of the first arm section.

5. The arm of claim 2 wherein the ribs are angled at bend lines for forming the plurality of linear sections angled with respect to each other; at least one of the angles being generally similar between the ribs.

6. The arm of claim 2 wherein the ribs are angled at bend lines for forming the plurality of linear sections angled with respect to each other; at least one of the angles being generally similar between the ribs.

7. The arm of claim 1 further comprising a knuckle having a vertical pivot axis therein, the knuckle coupled with a distal end of the first arm section.

8. The arm of claim 7 further comprising a second arm section coupled with the knuckle for horizontally pivoting on the knuckle with respect to the first arm section.

9. The arm of claim 2 further comprising a top plate and a bottom plate, the top plate and bottom plate interfacing with the plurality of ribs and extending along the length of the arm for forming the linear sections.

10. The arm of claim 1 wherein at least two of the linear sections have different lengths.

11. The arm of claim 1 wherein the linear sections are angled with respect to each other at different angles.
